(19) United States
(12) Patent Application Publication
(10) Pub. No.: US 2009/0090246 A1
(43) Pub. Date: Apr. 9, 2009

(54) COFFEE MAKER BREWBASKET WITH CARAFE LOCKING MECHANISM

(76) Inventor: WILLIAM L. SPENCER, Kelso, WA (US)

Correspondence Address: MARGER JOHNSON & MCCOLLOM, P.C., 210 SW MORRISON STREET, SUITE 400, PORTLAND, OR, 97204, US

(21) Appl. No.: 12/247,847

(22) Filed: Oct. 8, 2008

Related U.S. Application Data
(60) Provisional application No. 60/978,362, filed on Oct. 8, 2007.

(51) Int. Cl. A47J 31/58; A47J 31/10

(52) U.S. Cl. 99/290; 99/306

(57) ABSTRACT

According to an example embodiment, a coffee maker includes a housing, the housing structured to hold a carafe in a first position within a brewing area of the coffee maker. The coffee maker further includes a brewbasket adapted to connect to the housing and a locking mechanism. The locking mechanism is structured to engage the carafe and lock it into the first position in the brewing area, such that the carafe remains in the first position relative to the brewbasket, and the brew basket remains in first position locked directly to the housing by the locking mechanism as a second position of the brewbasket changes with respect to a reference point that is external to the coffee maker.

### CROSS REFERENCE TO RELATED APPLICATIONS

This application claims the benefit of U.S. Provisional Patent Application 60/978,362, entitled “COFFEE MAKER BREWBASKET WITH CARAFE LOCKING MECHANISM,” which was filed on 8 Oct. 2007. U.S. Provisional Patent Application 60/978,362 is incorporated by reference in its entirety.

### BACKGROUND

1. Technical Field

This disclosure relates generally to coffee makers, and in particular to a coffee maker brewbasket with a carafe locking mechanism.

2. Description of the Related Art

Coffee makers may be used in mobile environments, for example, such as in recreational vehicles, airplanes, or yachts. Coffee makers that are designed for stationary environments such as residential or business structures do not have locking mechanisms to lock the carafe in place and prevent it from sliding out of the coffee maker, making them unsuitable for mobile environments where they may be subjected to frequent jostling, tipping, or swaying due to the nature of land, air, or sea travel. In addition coffee makers for use in a stationary environment have no way to prevent the carafe from falling out when children are playing. A safety lock could also be incorporated to keep the carafe from falling out and causing harm.

### BRIEF DESCRIPTION OF THE DRAWINGS

FIG. 1 is a side elevation view illustrating a carafe and a brewbasket with a carafe locking mechanism in accordance with an example embodiment.

FIG. 2 is a front elevation view further illustrating the carafe and the brewbasket with the carafe locking mechanism according to the example embodiment.

FIG. 3 is a side elevation view illustrating the carafe locking mechanism of the example embodiment in additional detail.

FIG. 4 is a side elevation view further illustrating the interface between the carafe locking mechanism of the example embodiment and the carafe.

FIG. 5 is a cross-sectional view taken along lines 5-5 in FIG. 2 that further illustrates the brewbasket with carafe locking mechanism and the carafe of the example embodiment.

FIGS. 6A and 6B are side elevation views of the carafe and brewbasket in a housing shown in cross-section, FIG. 6A showing the carafe inserted under the brewbasket and FIG. 6B showing the carafe removed.

### DETAILED DESCRIPTION OF EXAMPLE EMBODIMENTS

In the detailed description below, an example embodiment is described. The description should not be viewed as limiting, however, but rather as serving to teach those of skill in the art the one or more inventive principles that may be shared among many different embodiments. For convenience and brevity, other components of coffee makers that are well-known and not critical for an understanding of the example embodiment may be omitted. In the following detailed description, some components may be described as being coupled or connected to other components. For purposes of this disclosure, coupled shall mean that one component is directly connected to another component, without any intervening parts, while connected shall mean that one or more intervening parts may be present.

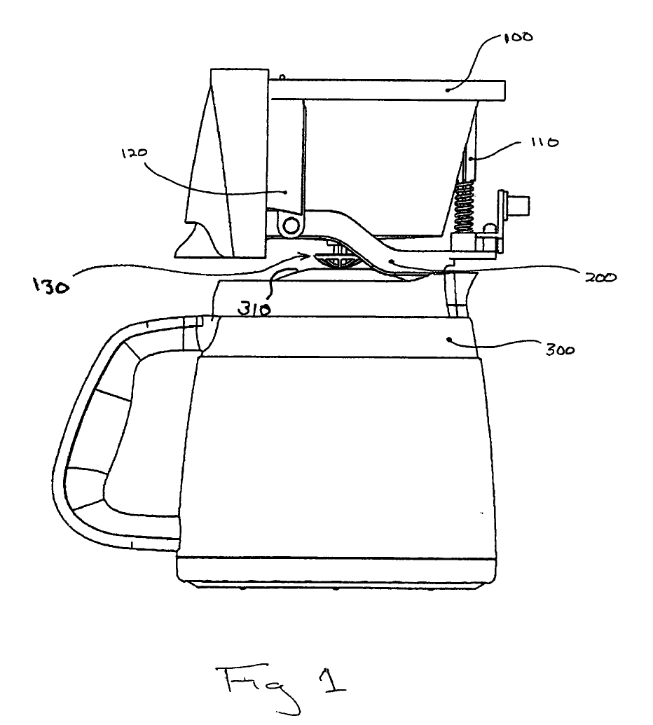

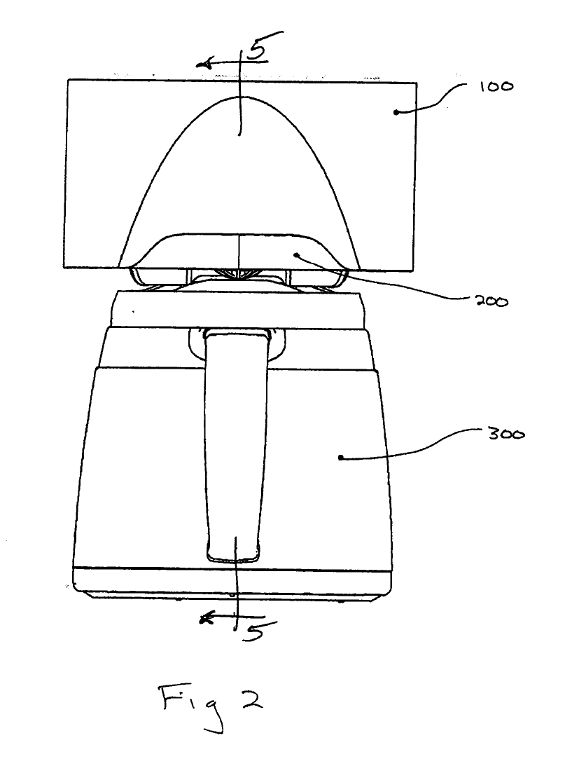

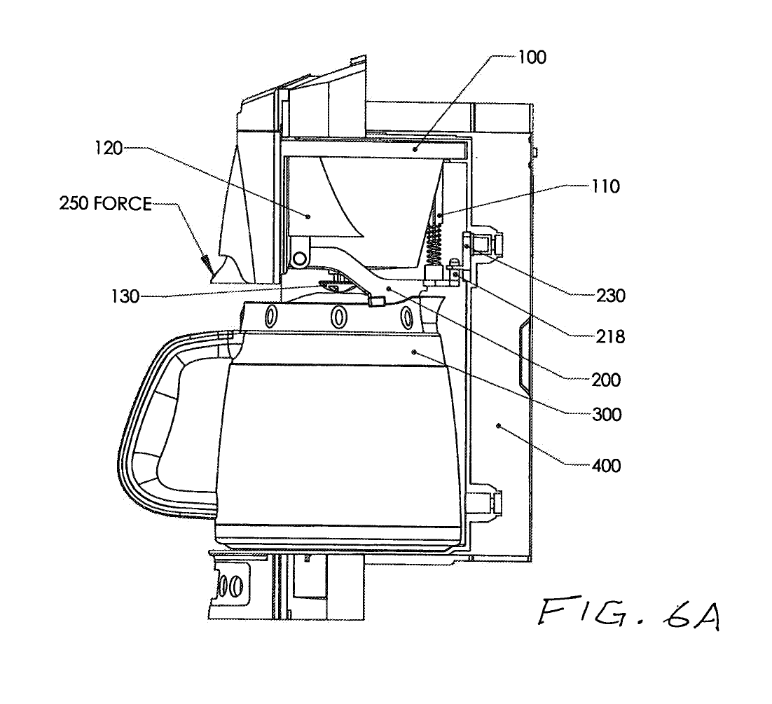

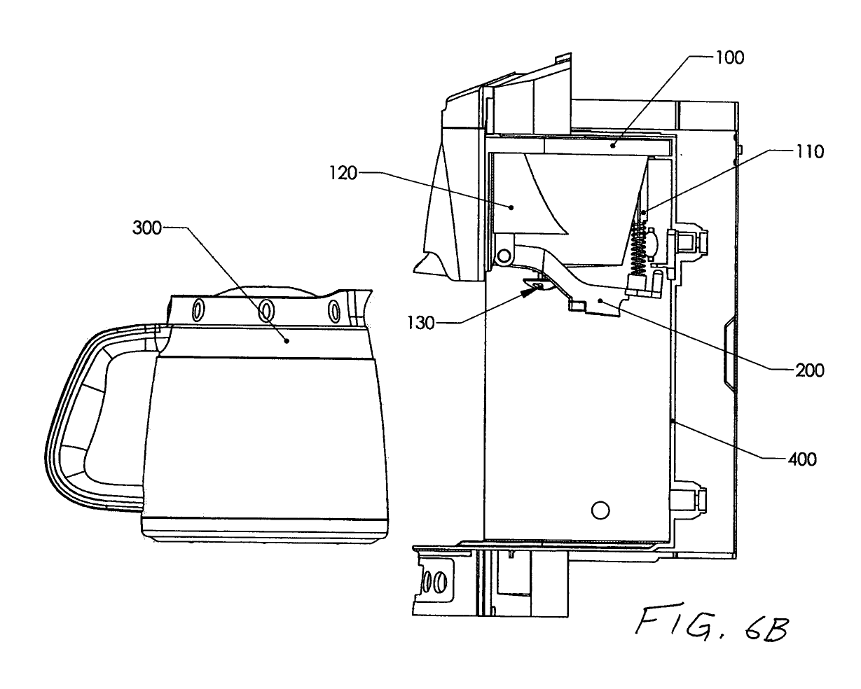

FIGS. 1 and 2 are side-view and front-view diagrams, respectively, that illustrate a carafe 300 and a brewbasket 100 with a carafe locking mechanism 200 in accordance with an example embodiment of the invention. The brewbasket 100, carafe locking mechanism 200, and carafe 300 with lid 310 are illustrated in the relative positions that they would typically be in when coffee is being brewed, i.e., the brewbasket 100 is inserted into the coffee maker housing (400) (see FIGS. 6A and 6B), and the carafe 300 is positioned below the brewbasket 100, resting on the coffee maker hot plate or other surface (not shown). Of course, the brewbasket 100, carafe locking mechanism 200, and carafe 300 having the relative position shown in FIG. 1 does not necessarily mean that the coffee maker is in the process of brewing coffee.

The brewbasket 100 includes a spring post 110 and two pivot mounts 120 (only one is shown in FIG. 1). The brewbasket 100 may further include a brewbasket drip guard 130 (pause and drip valve). As will become clear in the following description, the brewbasket 100 and carafe locking mechanism 200 are structured to maintain the carafe 300 in the relative position shown in FIGS. 1 and 2 regardless of any change of position of the coffee maker relative to its external environment e.g. in a moving boat, airplane or recreation vehicle.

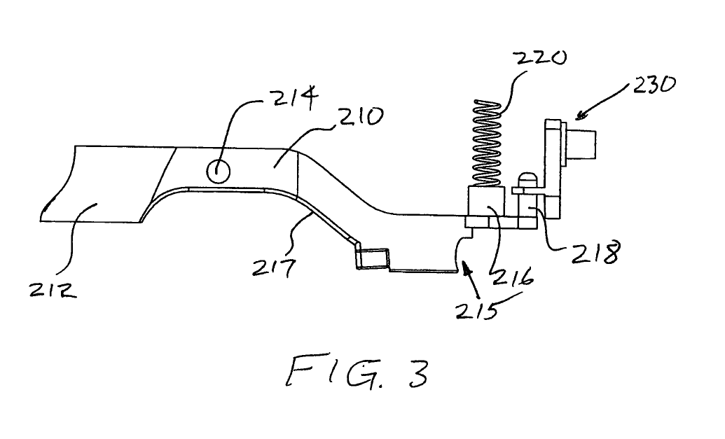

FIG. 3 is a side view illustrating the carafe locking mechanism 200 of the example embodiment in additional detail. Preferably, the carafe locking mechanism 200 is symmetric about a plane that is parallel to the plane of the paper upon which FIG. 3 is illustrated i.e. about center line 5-5 in FIG. 2. In other words, the side-view of the carafe locking mechanism 200 that is 180 degrees from the view shown in FIG. 3 is a mirror image of the side view illustrated in FIG. 3.

According to the example embodiment in FIG. 3, the carafe locking mechanism 200 includes a lever arm 210, a coil spring 220, and a guide 230. According to the example embodiment, the lever arm 210 has a contact portion 212, a pivot portion 214, a lid contact edge 215, a spring retainer portion 216, and a guide post portion 218. Preferably, the lever arm 210 is a single, integral piece of molded plastic, but in other alternative embodiments the lever arm 210 may be made of any known material or may have multiple, separately manufactured parts that are connected in any known manner.

The two pivot portions 214 of the lever arm 210 are structured to fit within the corresponding pivot mounts 120 (see FIG. 1) on opposite sides of the brewbasket 100. The lower portion of the spring 220 rests in the retainer portion 216, while the spring post 110 (see FIG. 1) of the brewbasket 100 is structured to fit within the upper portion of the spring 220. The guide post portion 218 is structured to fit within the guide 230.

It is contemplated that in alternative embodiments, the pivot portions 214 of the lever arm 210 may be structured to engage the housing of the coffeemaker rather than the brewbasket 100. That is, in alternative embodiments the carafe locking mechanism may be connected to the housing rather than the brewbasket.

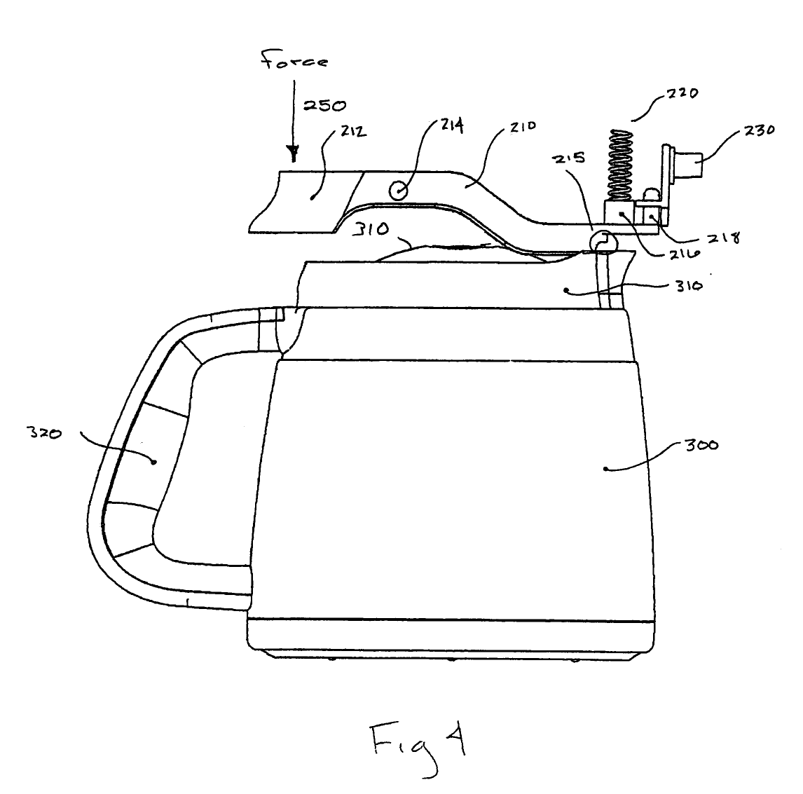

FIG. 4 is a side view diagram further illustrating the interface between the carafe locking mechanism 200 of the example embodiment and the carafe 300. For this view, the brewbasket 100 is not shown for clarity but it should be remembered that the two pivot portions 214 are coupled to the brewbasket 100 with the pivot mounts 120 and that the spring 220 fits around the spring post 110 of the brewbasket. The carafe 300 includes a lid 310 and handle 320.

In the absence of an external force that is applied to the contact portion 212 of the lever arm 210, the spring 220 is structured to apply a sufficient downward force to the end of the lever arm opposite the contact portion such that the lid contact edge 215 of the lever arm is maintained in engaging contact with lid 310 of the carafe 300. The contact between the lid contact edge 215 and the lid 310 maintains the carafe 300 in the relative position shown in FIGS. 1 and 2 and prevents the carafe from sliding out of the coffee maker due to motion of the plane, vehicle, or boat where the coffee maker is installed. The particular shape of the lid contact edge 215 is shown in FIG. 3 as a concave notch engageable inside a peripheral rim of the carafe lid 310. While this shape may vary from embodiment to embodiment, it is preferable that the profile of the lid contact edge match as closely as possible the corresponding surface of the lid 310 in order to achieve a superior holding quality. For example, according to other embodiments the lid contact edge 215 may have multiple pins protruding from the lever arm 210, while the lid 310 may have corresponding multiple holes, each hole structured to accommodate one of the pins. There are many other particular shapes for the lid contact edge 215 and corresponding shapes for the lid 310 that may be used, and a description of all possible combinations is not necessary for purposes of this disclosure. Alternatively, the lever arm and contact edge can be shaped to engage the body of the carafe itself, for example the carafe spout.

When a sufficient external force 250 is applied downwards on the contact portion 212 of the lever arm 210, the lid contact edge 215 is lifted up and away from the lid 310, compressing the spring 220 against the brew basket. This removal of contact between the lid contact edge 215 and the lid 310 allows the carafe 300 to be removed from the coffee maker. To replace the carafe 300 in the coffee maker, the force 250 may again be applied to the contact portion 212 and the carafe pushed into the coffee maker, or the carafe may simply be pushed into the coffee maker without applying a force to the contact portion 212. The lever arm can have a shallowly curved inclined underside 217 which serves as a cam engaged by the carafe spout and lid to lift the lid contact edge 215 temporarily against spring 220 out of way of the carafe spout and lid.

In the example illustrated embodiment, the guide post portion 218 and the guide 230 work cooperatively to ensure the range of motion of the lever arm 210 is consistent. The guide 230 may be attached to a convenient portion of the coffee maker housing. In FIGS. 6A and 6B the guide 230 is an L-shaped member having a vertical leg mounted via a bracket on the back wall of housing 400, and a forward-protruding horizontal leg, which is donut shaped in top view, to receive guide post portion 218. In alternative embodiments, the guide 230 and guide post portion 218 may not be present.

In some alternative embodiments, the spring 220 and the spring post 110 may not be necessary if the weight of the lever arm 210 is sufficient to maintain the lid contact edge 215 in contact with the lid 310 for most situations that are encountered in a mobile vehicle, airplane, or boat. In other alternative embodiments, the guide post portion 218 and the guide 230 may be omitted.

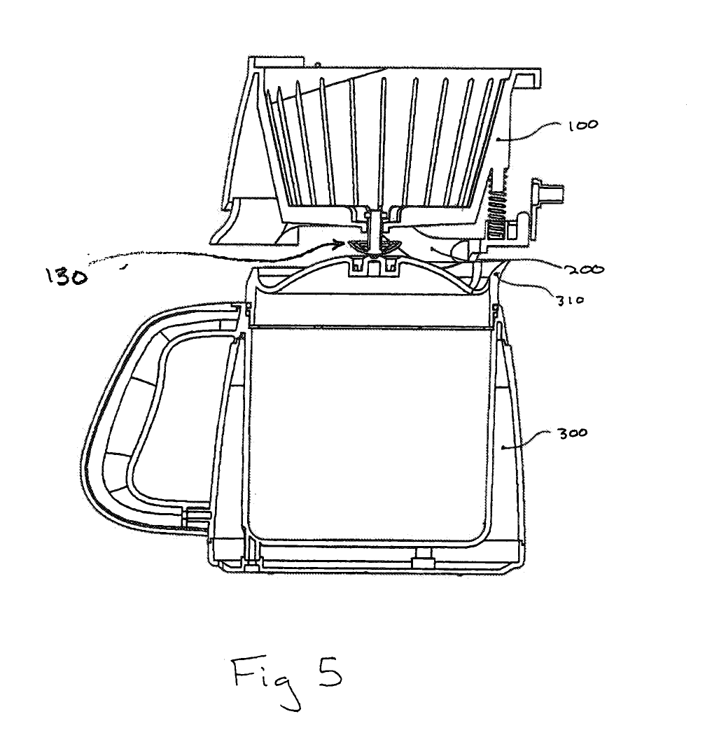

FIG. 5 is a cross-sectional diagram that further illustrates the brewbasket 100 with carafe locking mechanism 200 and the carafe 300 of the example embodiment. In the following paragraphs, some other example embodiments are described.

According to some example embodiments, a device includes a brewbasket and a carafe locking mechanism. The brewbasket and the carafe locking mechanism are structured to maintain a carafe in a first position relative to the brewbasket as a second position of the brewbasket changes with respect to a reference point that is external to the device such as the housing.

According to other example embodiments, a method of holding a carafe in place within a coffee maker includes connecting the carafe to a brewbasket of the automatic coffee maker. According to some embodiments, connecting the carafe to the brewbasket includes actuating a locking mechanism that is coupled to the brewbasket, the locking mechanism structured to engage the carafe.

According to some example embodiments, a coffee making system includes a brewbasket and a locking mechanism. The locking mechanism is structured to engage a carafe and hold the carafe in a fixed position relative to the coffee making system.

1. A coffee maker comprising:
a housing, structured to hold a carafe in a first position within a brewing area of the coffee maker;
a brewbasket adapted to connect to the housing; and
a locking mechanism, the locking mechanism structured to engage the carafe and lock it into the first position in the brewing area, such that the carafe remains in the first position relative to the brewbasket as a second position of the brewbasket changes with respect to a reference point that is external to the coffee maker.

2. The coffee maker of claim 1, in which the locking mechanism comprises a lever, the lever structured to release or engage the carafe from the first position.

3. The coffee maker of claim 1, in which the locking mechanism comprises a lever, the lever structured to release or engage the carafe from the first position when an external force is applied to the lever.

4. The coffee maker of claim 1, in which the locking mechanism further comprises a spring, the spring structured to maintain the locking mechanism in a locked position in the absence of an external force.

5. The coffee maker of claim 1, in which the locking mechanism further comprises pivot points.

6. The coffee maker of claim 5, in which the locking mechanism is structured to pivot about the pivot points when an external force is applied to a lever.

7. The coffee maker of claim 5, in which the pivot points are coupled to the brewbasket.

8. The coffee maker of claim 1, in which the brew basket locks together with the coffee maker housing when the locking mechanism is engaged with carafe.

9. The coffee maker of claim 1, in which the locking mechanism includes a lever mounted to pivot points and the pivot points are coupled to the housing.

10. A method of holding a carafe in place within a coffee maker comprises mechanically connecting the carafe to a brewbasket of the coffee maker and retaining the carafe within a brewbasket area of the coffeemaker during movement of the coffee maker.

11. The method of claim 10, in which connecting the carafe to the brewbasket comprises actuating a locking mechanism that is coupled to the brewbasket, the locking mechanism structured to releasably engage the carafe.

12. A coffee making system comprising:
a carafe;
a housing, the housing structured to hold a carafe in a first position within a brewing area of the coffee making system;
a brewbasket that is structured to couple to the housing; and
a locking mechanism coupled to the brewbasket, the locking mechanism structured to engage the carafe and maintain the carafe in the first position as the coffee making system moves relative to a fixed external point.
